(19) United States
(12) Patent Application Publication
(10) Pub. No.: US 2024/0429648 A1
(43) Pub. Date: Dec. 26, 2024

(54) A LOW-FORCE PULL-APART UNDERWATER CONNECTOR APPARATUS, SYSTEM, AND A METHOD OF MANUFACTURING

(71) Applicant: The United States of America as represented by the Secretary of the Navy, San Diego, CA (US)

(72) Inventors: Yolanda Meriah Arias-Thode, San Diego, CA (US); Eric Bozeman; David Bartholomew Chadwick, San Diego, CA (US); Kevin Richard Hardy, San Diego, CA (US)

(73) Assignee: The United States of America as represented by the Secretary of the Navy, San Diego, CA (US)

(21) Appl. No.: 18/436,416

(22) Filed: Feb. 8, 2024

Related U.S. Application Data
(60) Provisional application No. 63/484,107, filed on Feb. 9, 2023.

(51) Int. Cl. H01R 13/52; H01R 13/633; H01R 43/00; H02J 50/00

(52) U.S. Cl. CPC H01R 13/5219; H01R 13/633; H01R 43/005; H02J 50/001

(57) ABSTRACT

A low force pull-apart underwater connector apparatus, system, and a method of manufacturing. In one embodiment, a low-force pull-apart waterproof connector a receptacle having at least two receptacle pins, wherein the receptacle is electrically connected to a first wire, a plug having at least one plug pin, configured to selectively mate with the receptacle to form an electrical connection, wherein the at least one plug pin is oriented parallel to the at least two receptacle pins, and wherein the plug is electrically connected to a second wire, and a compressive seal sleeve filled with a marine-grade silicon grease tightly surrounding the electrical connection of the plug and the receptacle, and wherein the connection is operable to disconnect with the application of a low force.

### STATEMENT REGARDING FEDERALLY-SPONSORED RESEARCH AND DEVELOPMENT

The United States Government has ownership rights in this invention. Licensing inquiries may be directed to Office of Research and Technical Applications Naval Information Warfare Center Pacific, Code 72120, San Diego, CA, 92152; telephone (619) 553-5118; email: NIWC Pacific T2@us.navy.mil, referencing Navy Case No. 211,014.

### BACKGROUND

Subsea connectors facilitate the electrical connection of systems in marine environments and are a key technology in marine engineering. These connectors allow data and/or power transmissions between disparate systems including, but not limited to, robotics, power supplies, and sensors. Marine environments provide challenging conditions for connectors such as high ambient pressures and significant risks of shorting the attached systems. These challenges are exacerbated when operators are required to decouple connectors underwater. Typically, subsea connectors are increasingly difficult to disconnect at higher water pressures and intentionally designed so to maintain the electrical connection.

Recent developments in subsea connector technology have produced pressure-balanced oil-filled connectors, which provide an offsetting internal pressure in the connector to compensate for the high ambient pressure of deep-sea environments. However, these connectors are expensive, and involve complex disconnections and are ill-equipped for some use cases making them inappropriate for pressure compensation techniques. Current waterproof connectors have abundantly secure fastening mechanisms such as latches, straps, or screw-down locking sleeves. While secure, these features also pose environmental hazards by having a high pull-apart force during disconnection. Moreover, the electrical connections may be poor such that if these mechanisms are left disengaged, the connector might be pulled loose, become disconnected with slight vibrations, or it may not fully connect at all. Again this is all exacerbated when operating, especially at extreme depths of 2000 m or more.

There is a need for subsea connectors that require exceptionally low disconnection force, are simple to manufacture, and enable efficient deployment of subsea systems.

### SUMMARY

According to illustrative embodiments, a low-force pull-apart waterproof connector a receptacle having at least two receptacle pins, wherein the receptacle is electrically connected to a first wire, a plug having at least one plug pin, configured to selectively mate with the receptacle to form an electrical connection, wherein the at least one plug pin is oriented parallel to the at least two receptacle pins, and wherein the plug is electrically connected to a second wire, and a compressive seal sleeve filled with a marine-grade silicon grease tightly surrounding the electrical connection of the plug and the receptacle, and wherein the connection is operable to disconnect with the application of a buoyancy force.

Additionally, an energy harvesting system having a low-force pull-apart connector, comprising: an upper module of an energy harvesting system comprising a cathode and a buoyancy module, coupled to a low-force pull-apart connector, wherein the buoyancy module provides a buoyancy force to the low-force pull-apart connector, an lower module of an energy harvesting system further comprising a anode and a release mechanism, coupled to a low-force pull-apart connector, the low-force pull-apart connector configured to disconnect upon triggering the release mechanism, further comprising: a receptacle having at least two receptacle pins, wherein the receptacle is electrically connected to a first wire; a plug having at least one plug pin, configured to selectively mate with the receptacle to form an electrical connection, wherein the at least one plug pin is oriented parallel to the at least two receptacle pins, and wherein the plug is electrically connected to a second wire; and a compressive seal sleeve filled with a marine-grade silicon grease tightly surrounding the electrical connection of the plug and the receptacle, and wherein the connection is operable to disconnect with the application of a buoyancy force.

Additionally, a method of manufacturing a low-force pull-apart connector, the steps comprising providing a receptacle electrically connected to a first wire and having at least two receptacle pins, a plug electrically connected to a second wire and having at least one plug pin, a compressive seal sleeve, and a marine grade silicon grease; applying the silicon grease to the interior of the compressive seal sleeve and to the receptacle; inserting the receptacle into the compressive seal sleeve; applying additional grease to the plug; inserting the plug into the compressive seal sleeve until it is flush with the receptacle and mates with the receptacle, wherein the compressive seal sleeve seals the plug and the receptacle in the interior volume; injecting the interior volume with silicon grease near a mating interface between the plug and the receptacle; and mating the plug with the receptacle to form an electrical connection between an upper module and a lower module, configured to selectively disconnect, wherein the disconnect employs a low-force pull-apart disconnection that may be separated upon application of a low force.

It is an object to provide a Low-Force Pull-Apart Underwater Connector Apparatus, System, and a Method Of Manufacturing, including neutralizing high-ambient pressure, provide low-force pull-apart capability, and includes a design that is environmentally neutral, small, lightweight, low cost, and easily refurbished between dives.

It is an object to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The accompanying drawings, which are incorporated in and form a part of the specification, illustrate example embodiments and, together with the description, serve to explain the principles of the invention. Throughout the several views, like elements are referenced using like references. The elements in the figures are not drawn to scale and some dimensions are exaggerated for clarity. In the drawings:

FIG. 1 is an exemplary illustration of energy harvesting system having a low-force pull-apart connector.

FIG. 2A is an exemplary illustration of a low-force pull-apart waterproof connector in a disconnected state.

FIG. 2B is an exemplary illustration of a low-force pull-apart waterproof connector in a connected state.

FIG. 3 is an exemplary illustration of a corrosion link and a low-force pull-apart waterproof connector further comprising at least two ties.

FIG. 4A is an exemplary illustration of a receptacle FIG. 4B is an exemplary illustration of a plug and heat shrink wrapping.

FIG. 5 is a block-diagram illustration of a method of manufacturing a low-force pull-apart connector.

### DETAILED DESCRIPTION OF EMBODIMENTS

The disclosed apparatus, system, and method below may be described generally, as well as in terms of specific examples and/or specific embodiments. For instances where references are made to detailed examples and/or embodiments, it should be appreciated that any of the underlying principles described are not to be limited to a single embodiment, but may be expanded for use with any of the other apparatus, system, and method described herein as will be understood by one of ordinary skill in the art unless otherwise stated specifically.

References in the present disclosure to “one embodiment,” “an embodiment,” or any variation thereof, means that a particular element, feature, structure, or characteristic described in connection with the embodiments is included in at least one embodiment. The appearances of the phrases “in one embodiment,” “in some embodiments,” and “in other embodiments” in various places in the present disclosure are not necessarily all referring to the same embodiment or the same set of embodiments.

As used herein, the terms “comprises,” “comprising,” “includes,” “including,” “has,” “having,” or any variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or.

Additionally, use of words such as “the,” “a,” or “an” are employed to describe elements and components of the embodiments herein; this is done merely for grammatical reasons and to conform to idiomatic English. This detailed description should be read to include one or at least one, and the singular also includes the plural unless it is clearly indicated otherwise.

This disclosure may be used in subaquatic environments at depths from surface level to the seafloor or lakebed. Subaquatic environments may include oceans and imply the disclosure may be subjected to a wide range of ocean conditions including currents, high ambient pressures, and ocean temperatures. Additionally, subaquatic environments may include lakes or other bodies of water.

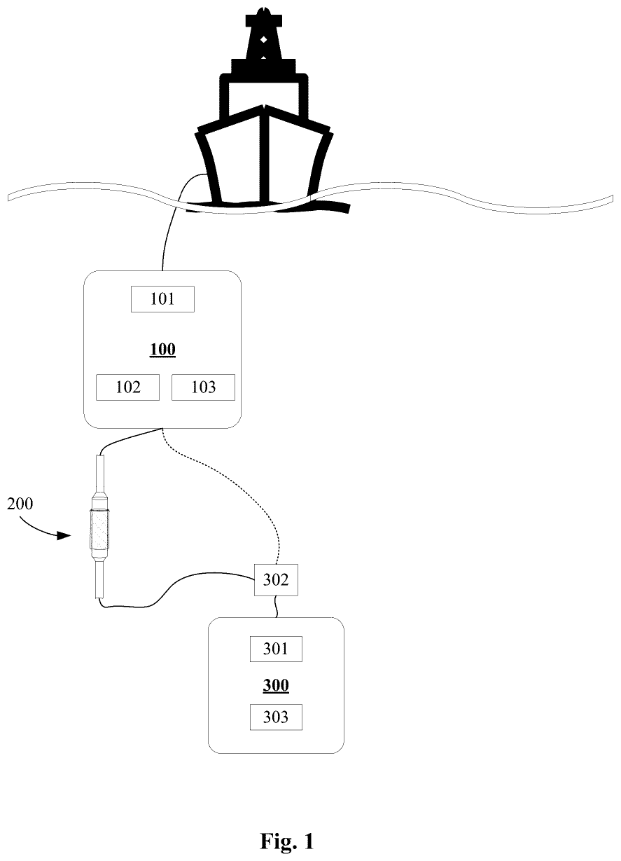

FIG. 1 is an exemplary illustration of an energy harvesting system having a low-force pull-apart connector comprising, consisting of, or consisting essentially of a self-buoyant upper module 100 having a cathode 101, a low-force pull-apart connector 200, and a weighted lower module 300. In one embodiment, this unit may be related to a microbial fuel cell and this upper module 100 can be used to carry other electronics for surveying or alternate oceanographic needs. However, this disclosure is not so limited.

Furthermore, FIG. 1 shows an aquatic vessel deploying an energy harvesting system by lowering an upper module 100 from the surface while connected to a connector 200, a release mechanism 302, and a lower module 300. As shown, the solid lines represent hard cables or lines connecting the systems, while the dotted line represents a release mechanism or corrosion link. As described herein, the lower module 300 can be deployed to a seafloor or lakebed when the corrosion link is selectively (e.g. remotely or at a pre-determined time) dissolved causing the negatively buoyant lower module 300 to either sink or rest on the seafloor. The connector 200 supplying an electrical connection between the upper 100 and lower 300 modules may then disconnect as a result of the buoyant force it receives from the self-buoyant upper module. Care is taken to ensure that the flow of electrical current is stopped before disconnecting (for lower currents this is not a concern). Accordingly, this method efficiently deploys an energy harvesting system 500 with a low-cost, reliable method of disconnecting the electrical link.

The upper module 100 further comprises a cathode 101, a buoyancy module 102, and harvesting electronics 103. A buoyancy module 102, in one embodiment, may be air and provide a sufficient buoyant force to float the upper module 100 unless restrained. In one embodiment, the upper module 100 contains the electronics 103 that handle energy monitoring, energy storage, data logging, and communications. In another embodiment, this energy harvesting system may be related to a microbial fuel cell and this upper module 100 can be used to carry other electronics for surveying or alternate oceanographic needs.

The lower module 300 may contain the energy harvesting anode 301 and a weight 303 that provides negative buoyancy to the energy harvesting system. The two modules are mechanically connected by a galvanic release mechanism 302. In one embodiment, the release mechanism 302 may be a “corrosion link” 60 that allows the upper module 100 and lower module 200 to separate upon a command from an acoustic receiver when a pre-determined event occurs (e.g. a specified depth is reached) or a countdown timer module (depending on how the system is configured), triggers the release. A direct current (DC) may be passed through the corrosion link 60 to speed up corrosion and cause the mechanical link holding the two modules together to dissolve. In one embodiment, the corrosion link is either stainless steel or inconel. Alternative release mechanisms, known to practitioners skilled in ocean lander design, may also be used.

The two modules may be electrically connected through a single connector 200. The low-force pull-apart (LFPA) connector 200 may be pulled apart by the upward force of the positively buoyant upper module 100. In one embodiment, the buoyance force sufficient to disconnect the connector 200 is greater than or equal to the force provided by one quart of submerged air in water.

The LFPA connector 200 may also be waterproof to protect electronics in case of an accidental disconnect during deployment or operation. Waterproof electrical connectors are typically very rigid and securely connected. These kinds of connectors typically require significant force to disengage the connector, which would require more weight on the leave behind lower module and more buoyancy on the recovered system. This disclosure describes a connector requiring a low-force to disconnect. As described previously, the force required to disconnect may be about the buoyancy force of 1 quart of air submerged in water. In another embodiment, the connector may not be designed to plug in underwater, only to be unplugged.

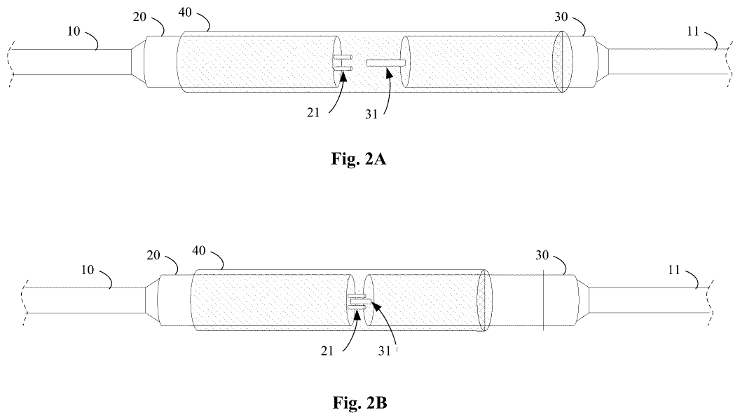

FIG. 2A is an exemplary illustration of an LFPA connector 200 in a disconnected state, comprising, consisting of, or consisting essentially of a first wire 10 and a second wire 11, a receptacle 20, at least two receptacle pins 21, a plug 30, at least one plug pin 31, and a compressive seal sleeve 40. Showing the same elements, FIG. 2B is an exemplary illustration of a low-force pull-apart waterproof connector in a connected state. In one embodiment, the LFPA connector 200 may comprise inexpensive and easy-to-find materials and may vary depending on the application. For example, the first wire 10 and the second wire 11 may be stainless steel to match one embodiment of the wiring of the anode 301, because using a different wire in the connector 200 would risk corrosion. In one embodiment, the at least two receptacle pins 21 and the at least one plug pin 31, which provides a more efficient and reliable electrical connection.

Additionally, marine-grade heat shrink tubing may be used for the compressive seal sleeve 40, but may also be replaced with any other insulating material that can add thickness to the conducting wire, provided that it is somewhat pliable, can prevent ingress of water, and can still be pulled out of the receptacle's tubing with little force. The compressive seal sleeve 40 may also be replaced with a different material tubing, such as silicone, as long as the material can survive the intended environment, prevent ingress of water, and does not increase the force required to pull the connector apart. The marine-grade silicon grease may be any grease that is not water-soluble, and is not electrically conductive. The lengths and diameters can vary by application, but increased size will most likely increase the force required to pull the LFPA connector 200 apart.

The receptacle 20 may require more materials than the plug 30, so it may be desirable for the receptacle 20 to be placed on the equipment that will be recovered (i.e. lower module), and the plug is left behind with the rest of the weight plate and other replaceable, sacrificial parts. The materials required may be similar for both pieces, but their assembly may be different. The following are examples embodiments of this disclosure. The proposed LFPA connector 200 has unique capabilities that allow the separation of two modules in environments including, but not limited to, high-pressure environments at ocean depths up to 2200 m, or more.

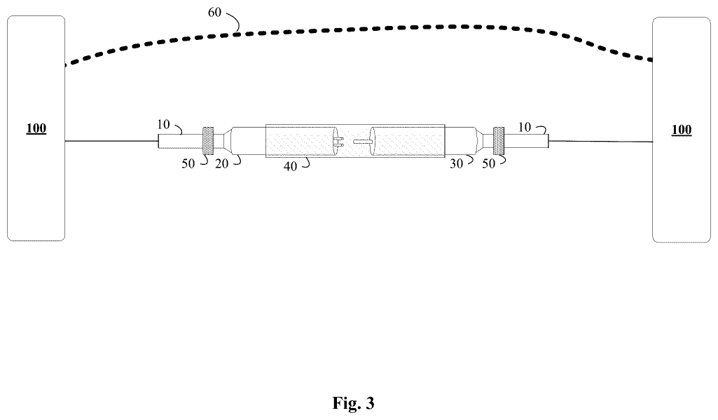

FIG. 3 is an exemplary illustration of a low-force pull-apart waterproof connector 200 further comprising, consisting of, or consisting essentially of at least two ties 50, and a corrosion link 60. In the embodiment shown in FIG. 3, the corrosion link 60 is coupled to two modules, similar to the release mechanism 302, as shown in FIG. 1. When the corrosion link is dissolved, the connector 200 may convert from a connected state to a disconnected state. Each configuration is viable for the applications discussed herein. This ties 50 ensures a tight fit to help prevent water from getting into the tubing before the connector is disengaged.

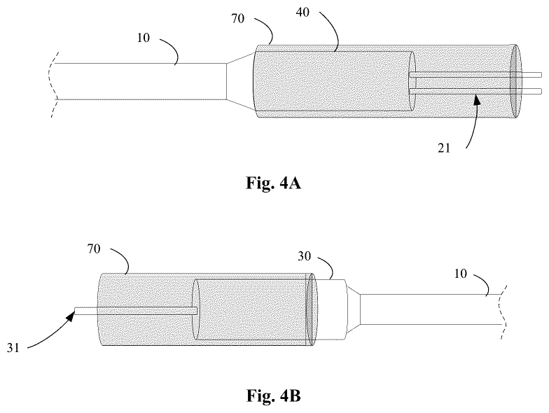

FIGS. 4A and 4B show the heat shrink wrapping around the at least two receptacle pins 21 and at least one plug pin 31. Marine-grade heat shrink tubing 70 may be used because it contains glue inside the tube that creates a watertight seal when heat is applied and the tubing shrinks over the wire. Several layers of increasingly larger diameter marine-grade heat shrink tubing 70 form a significantly thicker section of insulation around the flattened ends of the wires.

In one embodiment, this thicker section is flush with the two flattened ends, and extends about 1.5″ down the first and second wire 10. Furthermore, a 2.5″ long piece of a compressive seal sleeve with an inner diameter of 0.25″ may fitted around the thicker section of the insulation, with the end of the wires near the center of the compressive seal sleeve. The tubing fits snuggly around the layers of heat shrink, but a zip tie may also tightened around the tubing near the middle of the thicker section of insulation (also shown in FIGS. 4A and 4B).

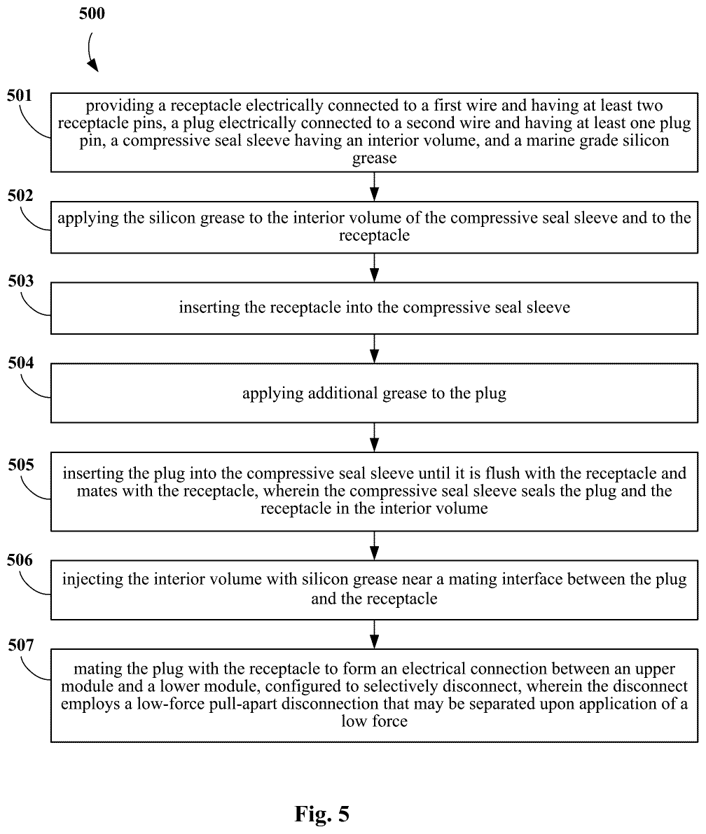

FIG. 5 is a block-diagram illustration of a method of manufacturing a low-force pull-apart connector, the steps comprising: providing a receptacle electrically connected to a first wire and having at least two receptacle pins, a plug electrically connected to a second wire and having at least one plug pin, and a compressive seal sleeve 501; applying a grease to the interior of the compressive seal sleeve and to the receptacle 502; inserting the receptacle into the compressive seal 503; applying additional grease to the plug 504; inserting the plug into the compressive seal sleeve until it is flush with the receptacle and mates with the plug, wherein the compressive seal sleeve seals the plug and the receptacle in the interior volume 505; the interior volume with silicon grease near a mating interface between the plug and the receptacle 506; mating the plug with the receptacle to form an electrical connection between an upper module and a lower module, configured to selectively disconnect, wherein the disconnect employs a low-force pull-apart disconnection that may be separated upon application of a low force 507. The result of a method of manufacturing a low-force pull-apart connector will be a connector pair, pin and socket, may be joined, making electrical contact.

The step of—providing a receptacle electrically connected to a first wire and having at least two receptacle pins, a plug electrically connected to a second wire and having at least one plug pin, a compressive seal sleeve, and a marine grade silicon grease 501—may further comprises a receptacle 20 and a plug 30 having no raised lettering (as is sometimes typical with these connectors) to enhance the watertight seal. Additionally, the receptacle 20 may comprise two pieces of grade 2 titanium wire, each of which is flattened. The two flattened ends of the titanium wire are spaced apart with the flat sides parallel to each other. In one embodiment, the diameter of the each wire is a 0.051″ diameter, the thickness is 0.029″, the length of the wire that is flattened is 0.75″ long, and the spacing between the wires of the receptacle 20 is approximately 0.029″. This is shown in FIGS. 4A and 4B, where the insulation has been removed to show the two flattened ends of the wires.

The step of—applying the silicon grease to the interior of the compressive seal sleeve and to the receptacle 502—may further comprise the silicon grease being marine grade.

The step of-inserting the receptacle into the compressive seal sleeve 503—may further comprise slicing the compressive seal sleeve to an appropriate size less than that of the combined length of the receptacle and plug, but sufficient to seal the connector 200. The compressive seal sleeve, for example, may comprise Tygon® tubing.

The step of—applying additional grease to the plug 504—may further comprise wherein the tubing is applied to prevent water from coming into contact with the titanium conductors both during operation, and after the connector has been pulled apart. This grease also helps the connector disengage with less force.

The step of—inserting the plug into the compressive seal sleeve until it is flush with the receptacle and mates with the receptacle, wherein the compressive seal sleeve seals the plug and the receptacle in the interior volume 505—wherein the interior volume comprises the interior of the compressive seal sleeve, which may be cylindrical, and is of a size to facilitate a watertight insertion of the plug and the receptacle. The seal volume may be filled with grease.

The step of—injecting the interior volume with silicon grease near a mating interface between the plug and the receptacle 506—may further comprise a syringe and thin gauge needle filled with silicone grease may be used to fill the interior volume of the silicone tube covering the mated connector pair. A syringe may be used to add new grease. One may insert the syringe between the heat shrink and the compressive seal sleeve, making sure that the tip is as far up the compressive seal sleeve as possible (the syringe should be so small/sharp to fit into the tubing and care taken to not puncture the tubing. The grease may be deposited near the mating interface of the receptacle 20 and the plug 30, where the pins connect. “Near” may be defined as sufficiently close for the grease to encompass the mating interface to provide additional watertight sealing advantages. Next, one may press the plunger to fill the tube with grease from the top, down towards the opening to contact with the wires 10. This may force out any air bubbles. Additionally, massaging of the interior volume to extract all remaining air may need to be done.

The step of—mating the plug with the receptacle to form an electrical connection between an upper module and a lower module, configured to selectively disconnect, wherein the disconnect employs a low-force pull-apart disconnection that may be separated upon application of a low force 507—may further comprise attaching the end of the LFPA connectors, each of the receptacle 20 and plug 30, are then fixed to their respective module, upper 100 and lower 300. The plug 30 may slide into the receptacle 20, forcing some of the grease out of the compressive seal sleeve 40. This excess can be wiped off, but there should still be enough grease inside the tubing to ensure a watertight seal. Prior to each use, the compressive seal sleeve 40 may be cleaned up, and new grease may be added. Cleaning the compressive seal sleeve should not involve taking anything apart unless there is some obstruction that would prevent the contacts from properly mating. In one embodiment, the low force may be a buoyant force.

When inserting the plug 30 into the receptacle 20, the compressive seal sleeve 40 may further comprise a direction marking to indicate the correct orientation of the plug. The plug 30 may be orientated such that its flattened end is parallel to the two flattened ends of the receptacle 20. The compressive seal sleeve 40 and thicker layers of heat shrink should center the plug's 30 conductor (i.e. wires). A user may feel when it is inserted correctly by the feel of a smooth insertion. The user should also take care to ensure that the receptacle 20 is secured to the structure that will be recovered, and the wire from the plug is secured to the structure that will be left behind. It is also important to be sure that the wires cannot get tangled during operation or deployment. When the equipment may be recovered by using either the timer release corrosion link 60 or the acoustic release corrosion link 60 that in turn makes the connector 200 pull apart, the central axis of the connector 200 align with the direction of the pulling force.

In an alternative embodiment approach, requiring no modifications to either connector, but slightly longer, uses an RMA-MP and a VMA-FS pair. The RMA-MP has a pin and the VMA-FS has a socket. The compressive seal sleeve 40 and silicone grease should be used as described above.

From the above description of a Low-Force Pull-Apart Underwater Connector Apparatus, System, and a Method Of Manufacturing, it is manifest that various techniques may be used for implementing the concepts of low-force pull-apart waterproof connector, an energy harvesting system having a low-force pull-apart connector, and a method of manufacturing a low-force pull-apart connector without departing from the scope of the claims. The described embodiments are to be considered in all respects as illustrative and not restrictive. The method/apparatus disclosed herein may be practiced in the absence of any element that is not specifically claimed and/or disclosed herein. It should also be understood that low-force pull-apart waterproof connector, an energy harvesting system having a low-force pull-apart connector, and a method of manufacturing a low-force pull-apart connector are not limited to the particular embodiments described herein, but is capable of many embodiments without departing from the scope of the claims.

What is claimed:

1. A low-force pull-apart waterproof connector, comprising:
a receptacle having at least two receptacle pins, wherein the receptacle is electrically connected to a first wire;
a plug having at least one plug pin, configured to selectively mate with the receptacle to form an electrical connection, wherein the at least one plug pin is oriented parallel to the at least two receptacle pins, and wherein the plug is electrically connected to a second wire; and
a compressive seal sleeve filled with a marine-grade silicon grease tightly surrounding the electrical connection of the plug and the receptacle, and wherein the connection is operable to disconnect with the application of a buoyancy force.

2. The low-force connector of claim 1, further comprising:
at least two ties, each tightly fastened on the receptacle and the plug to provide sealing; and
a corrosion link coupled to the first wire and the second wire configured to decouple when triggered.

3. The low-force connector of claim 1, wherein the at least two receptacle pins and the at least one plug pin are each flat.

4. The low-force connector of claim 1, wherein the receptacle and the plug are not wet-mateable connectors.

5. The low-force connector of claim 1, wherein the buoyancy force is equivalent to submerging one quart of air underwater, or more.

6. The low-force connector of claim 1, wherein the electrical connection is cut off from current flow before disconnection.

7. An energy harvesting system having a low-force pull-apart connector, comprising:
an upper module of an energy harvesting system comprising a cathode and a buoyancy module, coupled to a low-force pull-apart connector, wherein the buoyancy module provides a buoyancy force to the low-force pull-apart connector,
an lower module of an energy harvesting system further comprising a anode and a release mechanism, coupled to a low-force pull-apart connector,
the low-force pull-apart connector configured to disconnect upon triggering the release mechanism, further comprising:
a receptacle having at least two receptacle pins, wherein the receptacle is electrically connected to a first wire;
a plug having at least one plug pin, configured to selectively mate with the receptacle to form an electrical connection, wherein the at least one plug pin is oriented parallel to the at least two receptacle pins, and wherein the plug is electrically connected to a second wire; and
a compressive seal sleeve filled with a marine-grade silicon grease tightly surrounding the electrical connection of the plug and the receptacle, and wherein the connection is operable to disconnect with the application of a buoyancy force.

8. The energy harvesting system having a low-force pull-apart connector of claim 7, further comprising:
at least two ties, each tightly fastened on the receptacle and the plug to provide sealing; and
a corrosion link coupled to the first wire and the second wire configured to decouple when triggered.

9. The energy harvesting system having a low-force pull-apart connector of claim 7, wherein the at least two receptacle pins and the at least one plug pin are each flat.

10. The energy harvesting system having a low-force pull-apart connector of claim 7, wherein the electrical connection is cut off from current flow before disconnection.

11. The energy harvesting system having a low-force pull-apart connector of claim 7, wherein the receptacle and the plug are not wet-mateable connectors.

12. The energy harvesting system having a low-force pull-apart connector of claim 7, wherein the buoyancy force is equivalent to submerging one quart of air underwater, or more.

13. A method of manufacturing a low-force pull-apart connector, the steps comprising:
providing a receptacle electrically connected to a first wire and having at least two receptacle pins, a plug electrically connected to a second wire and having at least one plug pin, a compressive seal sleeve having an interior volume, and a marine grade silicon grease;
applying the silicon grease to the interior volume of the compressive seal sleeve and to the receptacle;
inserting the receptacle into the compressive seal sleeve;
applying additional grease to the plug;
inserting the plug into the compressive seal sleeve until it is flush with the receptacle and mates with the receptacle, wherein the compressive seal sleeve seals the plug and the receptacle in the interior volume;
injecting the interior volume with silicon grease near a mating interface between the plug and the receptacle; and
mating the plug with the receptacle to form an electrical connection between an upper module and a lower module, configured to selectively disconnect, wherein the disconnect employs a low-force pull-apart disconnection that may be separated upon application of a low force.

14. The method of manufacturing a low-force pull-apart connector of claim 13, further comprising the step of:
wrapping the receptacle and the plug in heat-shrink wrap.

15. The method of manufacturing a low-force pull-apart connector of claim 13, wherein the at least two receptacle pins and the at least one plug pin are flat and are oriented in parallel.

16. The method of manufacturing a low-force pull-apart connector of claim 13, wherein the grease is a marine-grade silicon grease.

17. The method of manufacturing a low-force pull-apart connector of claim 13, wherein the receptacle and the plug are not wet-mateable connectors.

18. The method of manufacturing a low-force pull-apart connector of claim 13, wherein the low force is a buoyant force.

19. The method of manufacturing a low-force pull-apart connector of claim 18, wherein the buoyancy force is equivalent to submerging one quart of air underwater, or more.

20. The method of manufacturing a low-force pull-apart connector of claim 13, wherein the electrical connection is cut off from current flow before disconnection.
